(19) United States
(12) Patent Application Publication
(10) Pub. No.: US 2022/0056808 A1
(43) Pub. Date: Feb. 24, 2022

(54) MAIN SEAL ASSEMBLY

(71) Applicant: ENTEGRIS, INC., Billerica, MA (US)

(72) Inventors: Jesse Sandoval, Colorado Springs, CO (US); Wayne G. Hambek, Frisco, TX (US); Kellen Myers, Azle, TX (US); Shandon T. Fullingim, Decatur, TX (US); Gregory J. Scherer, Fort Worth, TX (US); Robert Anderson, Wichita Falls, TX (US)

(21) Appl. No.: 17/407,934

(22) Filed: Aug. 20, 2021

Related U.S. Application Data
(60) Provisional application No. 63/068,910, filed on Aug. 21, 2020.

(51) Int. Cl. F01D 11/00; F16J 15/3284

(52) U.S. Cl. CPC F01D 11/003; F05D 2220/30; F16J 15/3284

(57) ABSTRACT

Technologies are described herein for a seal assembly for an engine, the seal having a circular carbon graphite mating surface and a circular carrier mating surface. A planar face of the circular carrier mating surface includes a circular bevel, which may be configured to receive a removable ringed insert. When inserted into the circular bevel, the ringed insert mates with a planar face of the circular carbon graphite mating surface. The carbon graphite mating surface, the circular carrier mating surface, and the circular of the carrier mating surface are aligned to have a common central axis along an engine shaft.

### TECHNICAL FIELD

The embodiments described herein pertain generally to increasing the product lifecycle for primary components of a turbine engine main seal and main shaft seal. However, such applications of the embodiments are non-limiting.

### BACKGROUND

In a turbine engine, the compressor drive turbine is to change thermal and kinetic energy into rotational energy, i.e., shaft horsepower, to turn the assembly shaft. The compressor drive turbine is turned by expanding gases that come through turbine nozzle guide vanes, driving the compressor, which may be referred to as a high pressure turbine (HPT).

Current seal technology for turbine engine main seals and main shaft seal applications utilize a steel seal rotating component that mates to a carbon graphite face seal. Together, these components are typically referenced as main shaft seals or face seal rings, which may be used to seal oil lubricant within gearboxes, to control combustion gas and air flow inside of a jet engine, etc.

However, because of high temperature thermal conductivity, high sliding speed rotations, vibrations, durability requirements, etc., the life-cycle of the steel seal rotating component and, particularly, the carbon graphite face seal is limited, and replacement thereof is costly in terms of time and resources.

### SUMMARY

In one example embodiment, an engine main seal has a carbon graphite mating surface and a carrier mating surface. A planar face of the carrier mating surface includes a circular bevel defined or carved therein, and the circular bevel is configured to receive a removable ringed insert. When inserted into the circular bevel, the ringed insert mates with a planar face of the carbon graphite mating surface. The carbon graphite mating surface, the carrier mating surface, and the circular bevel of the circular carrier mating surface are aligned to have a common central axis along a shaft of the engine.

In another example embodiment, a sealed shaft for a turbine engine has a rotatable carbon graphite mating surface, a rotatable carrier mating surface, and a ringed insert placed into a circular bevel that is defined or carved into a planar face of the carrier mating surface. The carbon graphite mating surface and carrier mating surface are aligned to have a common central axis along a shaft of the turbine engine; and a coefficient of thermal expansion (CTE) of the ringed insert are within a predetermined range of a CTE of the carrier mating surface. Further, the circular bevel and the ringed insert also share the common central axis as the carbon graphite mating surface and the carrier mating surface.

In at least one other example embodiment, a method of producing a sealed shaft of a turbine engine includes defining or otherwise carving a circular recess into a planar face of a circular carrier mating surface, heating the carrier mating surface to a predetermined temperature for a predetermined amount of time, inserting a removable ringed insert into the ringed recess, cooling the carrier mating surface, and mating a top planar surface of the removable ringed insert to a planar face of a circular carbon graphite mating surface.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example of a steel seal rotating component, in accordance with at least some embodiments described and recited herein.

FIG. 2 shows a non-limiting example of a seal for a turbine engine and/or main shaft, utilizing a steel seal rotating component that mates to a carbon graphite face seal, in accordance with at least some embodiments described and recited herein.

FIG. 3 shows a portion of an example of a partial seal assembly, in accordance with at least some embodiments described and recited herein.

FIG. 4 shows an operational flow for assembling a portion of the steel seal rotating component, in accordance with at least some embodiments described and recited herein.

FIG. 5 shows a cross-section of a steel seal rotating component, in accordance with at least some embodiments described and recited herein. Specifically, FIG. 5A shows an expanded view of the anti rotation dowels and FIG. 5B shows an expanded view of the recess and the removable insert.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

Although the materials utilized in the non-limiting example embodiments described and recited herein are subject to change and/or substitution, all within the intended scope thereof, the embodiments address concerns of lubricity and wear for, e.g., a standard carbon seal, as described and recited herein. The insert to the seal described and recited herein is referenced as being composed of silicon carbide (SiC), though such composition is non-limiting. Regardless, the pairing of the seal and insert exhibit low friction, relative to each other, and therefore the mutual rotation produces reduced wear and tear and a longer effective lifespan, relative to current face seals.

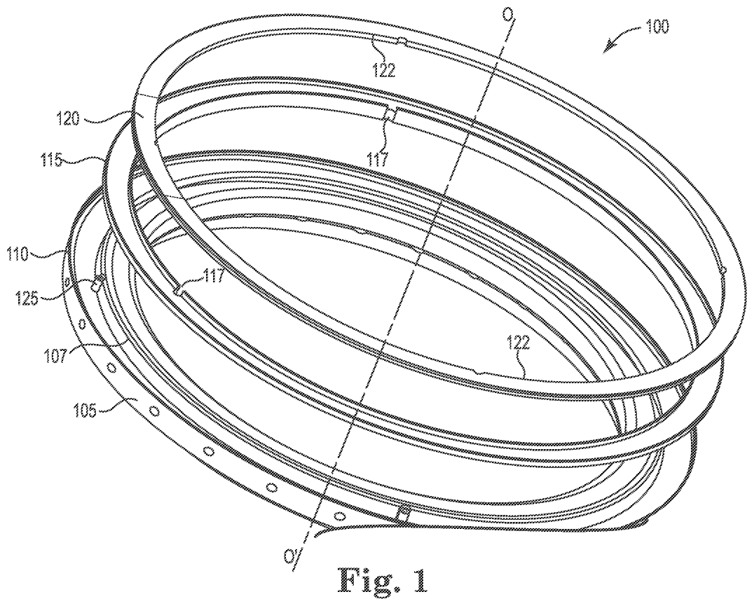

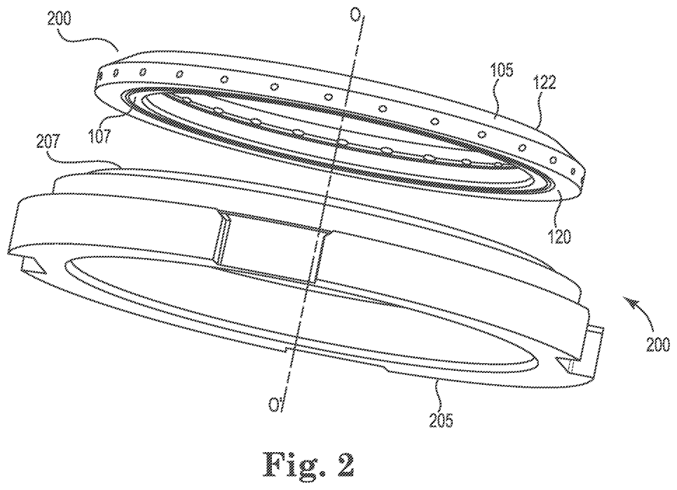

FIG. 1 shows an exploded view of a carrier assembly 100, which forms a part of a main seal, in accordance with at least some embodiments described and recited herein. FIG. 2 shows a partially exploded view of a main seal assembly 200 including carrier assembly 100 and mating seal 205. Carrier assembly 100 and mating seal 205 together form a seal that can, for example, retain oil lubricant within gearboxes and/or to control combustion gas and air flow inside of a turbine engine. When assembled and in operation, carrier assembly 100 rotates relative to mating seal 205. Main seal assembly 200 may be implemented as an engine main seal or as a main seal for a turbine engine shaft. Such embodiments are non-limiting, as the seal may have multiple applications in configurations of seals by which at least two mateable, mated, or joined surfaces are pressed and/or rotated relative to each other.

As shown in FIG. 1, carrier assembly 100 includes at least an insert carrier 105, a recess 110 defined or otherwise carved in insert carrier 105, optional buffer ring 115, removable insert 120, and one or more dowels 125 press-fit into insert carrier 105 to secure the optional buffer ring and insert 120 in recess 110. In at least some of the embodiments described and recited herein, each of the insert carrier 105, recess 110, buffer ring and insert 120 can be ring-shaped. In some embodiments, buffer ring 115 and insert 120 are each removable. In particular, insert 120 provides a sacrificial wear surface that is subjected to frictional forces, and that becomes worn over time. After a predetermined amount of time and/or a predetermined amount of wear, insert 120 can be removed and replaced with a new insert 120 presenting a new sacrificial wear surface that has not been subjected to wear negating the need to replace insert carrier 105 which can be a costly and time consuming endeavor.

Insert carrier 105 has a planar surface 107, and can be made of metal, metal alloy or ceramic. In some embodiments, insert carrier 105 can be made of a steel alloy. In alternative embodiments, insert carrier 105 can be made of other materials, including, but not by way of limitation, alloy steel, carbon steel, stainless steel, tool steel, maraging steel, and weathering steel.

Recess 110 can be a circular bevel defined in a planar face 107 of insert carrier ring 105. In some cases, recess 110 may be carved into the planar face 107 of insert carrier 105. Recess 110 may be defined or carved to share a same central radial axis O-O′ as insert carrier 105 and the mating seal 205 (FIG. 2). Recess 110 may be defined or otherwise carved to a uniform depth sufficient to receive, at least, insert 120 such that a planar face 122 of insert 120 uniformly extends above the planar face 107 of insert carrier 105. By having insert 120 received into recess 110 such that a planar face 122 of insert 120 extends above the planar face 107 of insert carrier 105, the planar face 107 of insert carrier 105 does not rub against the planar face 207 of the mating seal. Instead, the planar face 122 of insert 120 contacts and rubs against planar face 207 of mating seal 205 reducing the frictional forces to which insert carrier 105 is subjected. As such, instead of needing to repair or replace the insert carrier 105 due to wear, the insert 120 need only be removed and replaced as needed or desired. Thus, the occurrence of costly repairs or replacement of insert carrier 105 may be significantly reduced.

Buffer ring 115 may be a carbon graphite ring having circular dimensions, e.g., radius, circumference, and width, so as to be fitted in, received within, or otherwise engaged with recess 110. In some cases, buffer ring 115 is a semi-rigid carbon graphite ring such that it is capable of adsorbing any shocks and/or vibrations to which the seal assembly 200 may be subjected. Buffer ring 115 may be inserted between a bottom surface of recess 110 and a bottom surface of insert 120. Buffer ring 115 may serve to press insert 120 upward, away from a bottom portion of bevel 110, to such an extent that a planar face 122 of insert 120 extends above planar face 107 of insert carrier 105, as described herein

Insert 120 may be a silicon carbide or carbon graphite ring having circular dimensions, e.g., radius, circumference, and width, so as to be received within recess 110. In some cases, insert 120 may be a semi-rigid silicon carbide or carbon graphite ring. Again, the semi-rigidness of insert 120 may help to adsorb an shocks and/or dampen any vibrations to which the seal assembly 200 may be subjected. In some cases, insert 120 can be received within recess 110. The inclusion of buffer ring 115 in assembly 100 is optional; thus, insert 120 may be received within recess 110, either atop buffer ring 115 or atop a bottom surface of recess 110. Regardless, when inserted into bevel 110, a top portion, i.e., planar face 122, of insert 120 uniformly extends above the planar face 107 of insert carrier 105 so as to be fully mateable with a planar face 207 of mating seal 205 that is shown and described with reference to at least FIG. 2.

Dowel 125 may refer to one or more dowels that may be press-fit into recess 110 to secure buffer ring 115 and insert 120 within recess 110 of insert carrier 105. To accommodate the one or more dowels 125, buffer ring 115 includes corresponding notches 117, and insert 120 includes corresponding notches 122. Thus, as one or more dowels 125 press-fit into recess 110 to secure buffer ring 115 and insert 120, a physical accommodation is made to buffer ring 115 and insert 120 so that the respective one of dowels 125 does not compromise the integrity of either buffer ring or insert 120. It will be generally understood that the embodiments of the carrier assembly 100 described and recited herein are not limited to include one or more dowels 125. Instead, other non-limiting example embodiments may include other implementations of one or more removable fasteners to retain at least insert 120 within bevel 110 of insert carrier 105. Non-limiting examples of such fasteners may include clips, screws, or even thermal-resistant adhesives.

FIG. 2 shows a non-limiting example of a seal assembly 200 for a turbine engine and/or main shaft that includes carrier assembly 100 that is mateable to a mating seal 205, in accordance with at least some embodiments described and recited herein. Such embodiments are non-limiting, as the seal assembly 200 may have multiple applications in configurations of seals by which at least two mateable, mated, or joined surfaces are pressed and/or rotated relative to each other. Carrier assembly, described above with regard to FIG. 1, includes insert carrier 104 and rotates relative to mating seal 205, when assembled and in operation.

Mating seal 205 is a rotatable seal component that can be composed of, e.g., carbon graphite. A planar face 207 of mating seal 205 may be configured to be mateable with a planar face 122 of insert 120 that extends above the planar face 107 of insert carrier 105, as described herein. The planar face 122 of insert 120 may be pressed forward by optional buffer ring 115 serving as a platform between a bottom portion of recess 110 and a bottom portion of insert 120 or another force applied to a backside of insert carrier 105. Thus, a seal may be formed by the mating, engagement, or joining of the planar face 122 of insert 120 and the planar face 207 of mating seal 205. Other embodiments may include a spring-like equivalent to buffer ring 115 that serves to push insert 120 so that the planar face of insert 120 extends above the planar face of insert carrier 105.

When different materials for a seal assembly are to be mated or joined on at least a semi-permanent basis, one or all of the materials are at high risk of cracking and/or diminished performance due to excessive wear unless the materials each have a coefficient of thermal expansion (CTE) that is within an acceptable range of each other. CTE, as referenced herein, may be regarded as a change in a length of a substance per unit length for a specific change in temperature. Further, as referenced herein, CTE may change with temperature of the respective material and may be expressed an “in per inch per degree,” with the temperatures referenced herein being measured on the Fahrenheit scale. A hindrance of such thermal expansion is likely to result in internal stress for the respective material. As defined or carved in insert carrier 105, recess 110 may serve to create a seal surface area to facilitate vectoring of the coefficient of thermal expansion (CTE) induced by seal face movement and to further serve as a locking mechanism as the seal rotates the larger surface that is mateable to the insert carrier 105. Vectoring, as referenced herein, may refer to a change of reference point as a change in temperature affects a respective object. Such changes may be attributed to thermal expansion, i.e., a fractional change in size of material, including linear expansion, areal expansion, and volumetric expansion. CTE, then, may be regarded as the ratio of the fractional change in size of the material to its change in temperature and may be referenced by the International System of Units (SI) unit inverse kelvin (K-1 or 1/K) or the equivalent acceptable non SI unit inverse degree Celsius (° C.-1 or 1/° C.).

As such, in accordance with at least some of the embodiments described or recited herein, a coefficient of thermal expansion (CTE) of insert 120 is within a predetermined range of a CTE of insert carrier 105 and/or buffer ring 115. Similarly, a CTE of insert 120 is also within a predetermined range of a CTE of mating seal 205. Typically, though not exclusively, the predetermined range is 15%. In general, the better matched the CTE is of each of these components (e.g. insert carrier 105, buffer ring 115, and mating seal) the more likely each components will “grow” and “shrink” synchronously as the temperature in the section of the engine in which they are located in increases/decreases as a result of the engine cycling up or down.

As such, the materials for each of the insert carrier 105, optional buffer ring 115, removable insert 120 and mating seal 205 should be selected accordingly. In one embodiment: the insert carrier 105 is composed of steel; insert 120 is composed of silicon carbide (SiC); and mating seal 205 is composed of carbon graphite. Optional buffer ring 115 can also be carbon graphite.

The embodiments of seal assembly 200, particularly insert carrier 105 in combination with at least insert 120, described and recited herein are designed and configured to uniquely handle, in a cost- and resource-efficient manner, the corrosive effects typically caused by high temperature thermal conductivity, high slide speed rotations, vibrations, and other physical influences thereon, during use of a turbine engine. That is, seal assembly 200, which includes insert carrier 105, and mating seal 205 rotate relative to each other. A planar face 122 of insert 120 extends above the planar face 107 of insert carrier 105 to engage with the planar face 207 of mating seal 205, in part, to form a seal to, e.g., retain oil lubricant within gearboxes and/or to control combustion gas and air flow inside of a turbine engine. Further, as the physical influences described above cause wear and degradation of insert 120, which may be composed of silicon carbide (SiC), insert 120 may be replaced. Replacement of a SiC or substantially similar ringed insert comes with a significant savings in both time, cost, and effort in contrast to replacing insert carrier 105 in its entirety. That is, absent insert 120, at least the planar face of insert carrier 105 would require more frequent repair and/or replacement as it mates and rubs against the planar mating seal 205 as they rotate relative to each other.

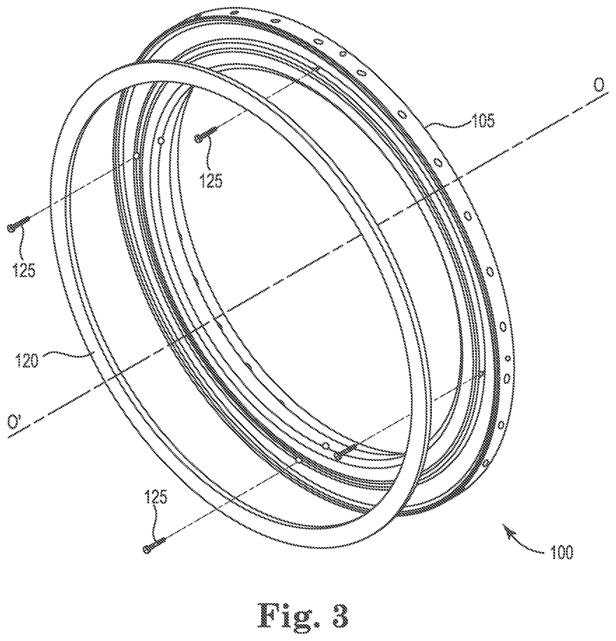

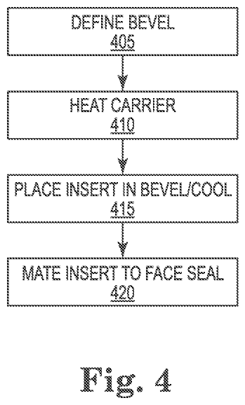

FIG. 3 shows a portion of an example of a partial seal assembly 100, in accordance with at least some embodiments described and recited herein, to illustrate the assembling or portions of manufacturing of assembly 100. Assembly 100 may be provided to a manufacturer intact or disassembled as part of a seal “kit” or package. Further, assembly 100 may be provided separate from mating seal 205. Accordingly, regardless of how assembly 100 is provided, similar to the depiction and description of FIG. 1, assembly 100 may include, at least, insert carrier 105, removable buffer ring 115, removable insert 120, and one or more dowels 125.

As part of the assembly process, a recess 110 may be defined or otherwise carved into a planar face of insert carrier 105 as a circular bevel, sharing a same central radial axis as insert carrier 105 and face seal 205. Recess 110 may be defined or carved, using one or more tools known in the art, e.g., metal lathe, to a uniform depth sufficient to receive, optionally buffer ring 115, as well as insert 120.

As also part of the assembly process, insert carrier 105 may be heated in an industrial oven to temperatures substantially in the range of 325° F. for at least 15 minutes, resulting in an expansion of insert carrier 105. After the heated insert carrier 105 cools at a room temperature of approximately 72° F. for approximately ten (10) minutes, resulting in a partial compression of insert carrier, buffer ring 115 may optionally be inserted prior to insert 120 being inserted to bevel 110. Alternative embodiments may contemplate a variance of plus-or-minus 15° F. and/or plus-or-minus two (2) minutes for the heating of insert carrier 105, as well as a variance of plus-or-minus two (2) minutes for the cooling of the insert carrier. Accordingly, as insert carrier 105 cools and compresses further, insert 120 may be securely locked within bevel 110, so as not to become dislodged during operation of the turbine engine.

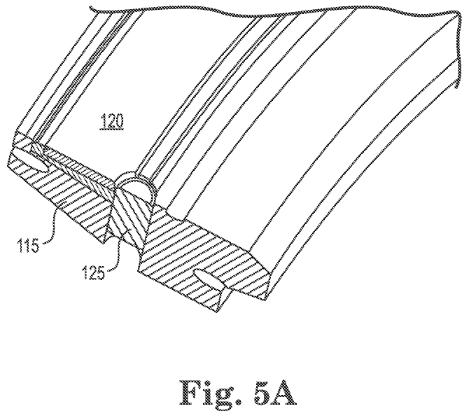

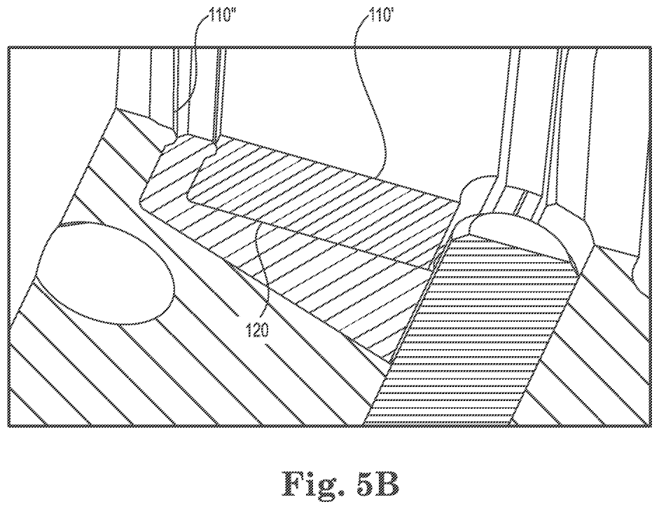

That is, buffer ring 115 and insert 120 may be inserted into recess 110 of expanded carrier 105, after carrier 105 has been heated. At that time, a width of recess 110 between an inner circumference 110′ and an outer circumference 110″ (see FIG. 5) thereof is also expanded, relative to the respective circumference measurements when carrier 105 is cooled to room temperature.

Buffer ring 115 and insert 120 are received into recess 110 such that notches 117 of buffer ring 115 and notches 122 of insert 120 align properly to accommodate respective ones of dowels 125 therein. Thus, buffer ring 115 and insert 120 are secured in place relative to each other.

As carrier 105 cools to room temperature, with buffer ring 115 and insert 120 fit into recess 110, the width of recess 110 contracts, thus acting to securely hold both buffer ring 115 and insert 120 in place relative to recess 110.

Accordingly, buffer ring 115 may be provided as a carbon graphite ring having circular dimensions so as to be fitted into recess 110 when insert carrier 105 is partially cooled. Buffer ring 115, or a spring equivalent, presses insert 120 so that a planar face of insert 120 extends above the planar face of insert carrier 105.

Further, insert 120 may be provided as a SiC or carbon graphite ring having circular dimensions so as to be fitted into bevel 110 when insert carrier 105 is partially cooled. When inserted into bevel 110, a top portion, i.e., planar face, of insert 120 uniformly extends above the planar face of insert carrier 105 so as to engage fully with a planar face of face seal 205.

FIG. 4, therefore, lists operations for producing assembly 400, as described above. Accordingly, FIG. 4 lists the following operations:

1) Define or otherwise carve bevel 110 into a planar face of insert carrier 105.

2) Heat insert carrier 105 to approximately 325° F. for at least 15 minutes.

3) Receive buffer ring 115 and insert 120 into recess 110 of partially cooled insert carrier 105.

3a) Cool insert carrier 105 to room temperature.

4) Mate a top surface of insert 120 to a planar face of face seal 205 to form a seal as carrier 105 and face seal 205 are mechanically moved towards each other, and buffer ring 115 or spring equivalent pushes a top surface of insert 120 above a top planar surface of the mating surface of the insert carrier 105.

As set forth above, replacement of insert 120 comes with a significant savings in both time, cost, and effort in contrast to replacing insert carrier 105 in its entirety, which happens absent insert 120 and the planar face of insert carrier 105 and the planar face seal 205 mate as they rotate relative to each other. Insert 120 may be replaced when worn down to a predetermined level or a predetermined time, e.g., when the top face of insert 120 no longer extends above the planar face of the carrier mating surface, when a wear pattern produces an imminent expectation the top face of insert 120 no longer extending above the planar face of the carrier mating surface, or after insert 120 has been used for a predetermined period of time.

Accordingly, insert 120 may be replaced following the operations listed above, shown in FIG. 4. As a precursor to those operations, insert carrier 105 may be separated from face seal 205. In a non-limiting example implementation of the operation for replacing insert 120, the heating of insert carrier 105 may be performed with a worn insert 120 still within bevel 110. Thus, operation (2) may be followed by removing the worn insert 120, and optionally removing buffer ring 115, prior to performing operation (3) of inserting a replacement insert 120.

Similarly, buffer ring 115 may also be replaced following the operations listed above, shown in FIG. 4. That is, buffer ring 115 may also be subjected to forces and influences that cause wear and degradation of insert 120. Accordingly, buffer ring 115 may be replaced in the same manner as insert 120, though at a reduced frequency.

FIG. 5 shows a cross-section of an example of a steel seal rotating component, in accordance with at least some embodiments described and recited herein.

In FIG. 5, dowel 125 is accommodated by a notch 117 of insert 115 and a notch 122 of insert 120. Buffer ring 115, or a spring equivalent, and insert 120 may be inserted into recess 110 of expanded carrier 105, while carrier 105 has been heated and therefore a width of recess 110 between an inner circumference 110′ and an outer circumference 110″ thereof is expanded relative to the respective circumference measurements when carrier 105 is cooled to room temperature. Notches 117 of buffer ring 115 and notches 122 of insert 120 align properly to accommodate respective ones of dowels 125 therein. Thus, buffer ring 115 and insert 120 are secured in place relative to each other. As carrier 105 cools to room temperature, the width of recess 110 contracts, thus securely holding both buffer ring 115 and insert 120 in place relative to recess 110.

### ASPECTS

Aspect 1: A seal, comprising:

a face seal having a carbon graphite mating surface; and

an insert carrier having a carrier mating surface,

wherein a planar face of the carrier mating surface includes a bevel defined therein, the bevel being configured to receive:

a removable ringed insert that, when inserted into the bevel, is mateable with a planar face of the carbon graphite mating surface,

wherein the carbon graphite mating surface, the carrier mating surface, and the bevel of the carrier mating surface are aligned along a common central axis along a shaft of the engine.

Aspect 2: The seal of Aspect 1, wherein the removable ringed insert includes:

a carbon graphite buffer ring to engage with the bevel carved in the planar face of the carrier mating surface; and

a silicon carbide seal ring to mate with a planar face of the carbon graphite mating surface.

Aspect 3: The seal of either of Aspect 1 or Aspect 2, further comprising a removable fastener to retain the removable ringed insert within the bevel of the carrier mating surface.

Aspect 4: The seal of any one of Aspects 1-3, wherein a top portion of the removable fastener is lower than a top of the removable ringed insert.

Aspect 5: A seal for a shaft of a turbine engine, comprising:

a rotatable carbon graphite mating surface;

a rotatable carrier mating surface,

wherein the carbon graphite mating surface and carrier mating surface are aligned to have a common perpendicular axis along a shaft of the turbine engine; and

a ringed insert placed into a circular bevel carved in a planar face of the carrier mating surface, a coefficient of thermal expansion (CTE) of the ringed insert being within a predetermined range of a CTE of the carrier mating surface,

wherein the circular bevel and the ringed insert have the common perpendicular axis as the carbon graphite mating surface and the carrier mating surface.

Aspect 6: The seal of Aspect 5, wherein the ringed insert is placed into the circular bevel carved in the planar face of the carrier mating surface after the carrier mating surface has been heated to at least 325° F. for a predetermined amount of time.

Aspect 7: The seal of either Aspect 5 or Aspect 6, wherein the ringed insert is placed into the bevel carved in the planar face of the carrier mating surface atop a carbon graphite buffer ring.

Aspect 8: The seal of any one of Aspects 5-7, wherein the ringed insert is a silicon carbide (SiC) seal ring of which a top surface mates with a planar face of the carbon graphite mating surface.

Aspect 9: The seal of any one of Aspects 5-8, wherein the ringed insert is retained in the circular bevel carved in the planar face of the carrier mating surface by multiple anti-rotation dowels that are press-fit within the circular bevel.

Aspect 10: The seal of any one of Aspects 5-9, wherein the coefficient of CTE of the ringed insert is within the predetermined range of 15% of the CTE of the carrier mating surface.

Aspect 11: A method of assembling at least a portion of a seal for a shaft of a turbine engine, comprising:

defining a ringed recess into a planar face of a carrier mating surface;

heating the carrier mating surface to a predetermined temperature for a predetermined amount of time;

inserting a removable ringed insert into the ringed recess; and

cooling the carrier mating surface.

Aspect 12: The method of Aspect 11, wherein the predetermined temperature is at least 325° F. and the predetermined amount of time is at least 15 minutes.

Aspect 13: The method of either of Aspect 11 or Aspect 12, wherein the removable ringed insert includes a silicon carbide seal ring to mate with the planar face of the carbon graphite mating surface.

Aspect 14: The method of any one of Aspects 11-13 wherein the removable ringed insert further includes a carbon graphite buffer ring to engage with the ringed recess defined in the planar face of the carrier mating surface.

Aspect 15: The method of any one of Aspects 11-14, wherein a coefficient of thermal expansion (CTE) of the ringed insert is within 15% of a CTE of the carrier mating surface.

Aspect 16: The method of any one of Aspects 11-15, further comprising securing the ringed insert to the ringed recess using multiple anti-rotation dowels that are press-fit within the recess.

Aspect 17: The method of any one of Aspects 11-16, further comprising replacing the removable ringed insert when the removable ringed insert has worn to a predetermined level.

Aspect 18: The method of any one of Aspects 11-17, further comprising replacing the removable ringed insert when the removable ringed insert has been used for a predetermined amount of time.

Aspect 19: The method of any one of Aspects 11-18, further comprising mating a top planar surface of the removable ringed insert to a planar face of a carbon graphite mating surface.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A engine seal, comprising:
a mating seal defining a mating surface; and
a carrier having a planar surface and a recess defined in the planar surface,
the recess being configured to receive:
a removable insert that, when inserted into the recess, has a contact surface that extends above the planar surface of the carrier and that is mateable with the mating surface of the mating seal,
wherein the mating seal, insert carrier and removable insert are aligned to have a common central axis.

2. The engine seal of claim 1, wherein the removable insert includes:
a buffer ring to engage with the recess defined in the planar face of the carrier such that it is disposed between the carrier and the removable insert.

3. The engine seal of claim 2, further comprising:
a removable fastener to retain the removable insert within the recess defined in the carrier.

4. The engine seal of claim 1, wherein the mating seal is composed of carbon graphite, and the removable insert is composed of silicon carbide.

5. A seal comprising:
a rotatable carbon graphite mating surface;
a rotatable carrier mating surface,
wherein the carbon graphite mating surface and carrier mating surface are aligned to have a common central axis; and
a removable insert disposed within a circular bevel defined in a planar face of the carrier mating surface, a coefficient of thermal expansion (CTE) of the removable insert being within a predetermined range of a CTE of the carrier mating surface,
wherein the circular bevel and the ringed insert have the same common central axis as the carbon graphite mating surface and the carrier mating surface.

6. The seal of claim 5, further comprising a carbon graphite buffer ring, wherein the ringed insert is disposed in the circular bevel carved in the planar face of the carrier mating surface atop the carbon graphite buffer ring.

7. The seal of claim 5, wherein the removable insert is a silicon carbide (SiC) ring of which a planar surface thereof mates with a planar face of the carbon graphite mating surface.

8. The seal of claim 5, wherein the removable insert is retained in the circular bevel by one or more anti-rotation dowels that are press-fit within the circular bevel.

9. The seal of claim 5, wherein the coefficient of CTE of the removable insert is within the predetermined range of 15% of the CTE of the carrier mating surface.

10. The seal of claim 5, wherein the coefficient of CTE of the removable insert is within the predetermined range of 15% of the CTE of the carbon graphite mating surface.

11. A method of producing a seal, comprising:
defining a circular recess in a planar face of an insert carrier;
heating the insert carrier to a predetermined temperature for a predetermined amount of time;
inserting a removable ringed insert into the circular recess;
cooling the insert carrier; and
mating a planar surface of the removable ringed insert to a planar face of a carbon graphite mating seal.

12. The method of claim 11, wherein the predetermined temperature is at least 325° F. and the predetermined amount of time is at least 15 minutes.

13. The method of claim 11, wherein the removable ringed insert includes a silicon carbide seal ring to mate with the planar face of the carbon graphite mating seal.

14. The method of claim 13, wherein the removable ringed insert further includes a carbon graphite buffer ring to engage with the circular recess defined in the planar face of the insert carrier.

15. The method of claim 11, wherein a coefficient of thermal expansion (CTE) of the ringed insert is within 15% of a CTE of the insert carrier.

16. The method of claim 11, further comprising securing the ringed insert to the circular recess using one or more anti-rotation dowels that are press-fit within the recess.

17. The method of claim 11, further comprising replacing the removable ringed insert when the removable ringed insert has worn to a predetermined level.

18. The method of claim 11, further comprising replacing the removable ringed insert when the removable ringed insert has been used for a predetermined amount of time.
